(19) United States
(12) Patent Application Publication
(10) Pub. No.: US 2009/0032653 A1
(43) Pub. Date: Feb. 5, 2009

(54) Trash bag holder and transporter

(76) Inventors: Jimmy Gilligan, Northport, NY (US); Leo Lenna, Northport, NY (US)

Correspondence Address: Law Office of Leo G. Lenna, 1 Makamah Beach Road, Northport, NY, 11768, US

(21) Appl. No.: 12/214,045

(22) Filed: Jun. 17, 2008

Related U.S. Application Data
(63) Continuation of application No. 11/818,255, filed on Jun. 14, 2007.

(51) Int. Cl. B65B 67/12; B62B 1/14; B65F 1/14; B62B 1/22

(52) U.S. Cl. 248/98; 280/47.24; 248/101

(57) ABSTRACT

The present invention is a bag holder/transport apparatus for use with plastic trash bags either outdoors or indoors. A rim system is provided with a frame, a foot peg for pushing the end of the rim/frame into the ground and a wheelbase. The present apparatus can be used to fill, and wheel a filled bag to a disposal point after filling.

### CROSS-REFERENCE TO RELATED APPLICATION

This application is a continuation of U.S. application Ser. No. 11/818,255 filed on Jun. 14, 2007, the disclosure of which is incorporated herein by reference in is entirety.

### FIELD OF THE INVENTION

The present invention relates generally to the field of trash and lawn bag holders and more particularly to a trash and lawn debris bag holding system that when in the horizontal position can be secured in place and when partially filled moved to an upright position and wheeled to a place for removal and disposal of the filled bag. The present invention is also directed to a trash bag securing double rim system that secures the trash bag in place by tightly sandwiching the trash bag between the two rims and releases the trash bag when the first rim is lifted away from the second rim. The trash bag securing double rim system is used with the trash and lawn bag wheeled apparatus of the present invention.

### BACKGROUND OF THE INVENTION

Yard waste removal has long been an endless weekend task completed by homeowners all over the world. In many municipalities, yard waste, such as leaves and grass clippings, is considered to be recyclable material and is therefore directed to compost facilities. These municipalities will dispose of yard waste separately than normal trash for recycling. As such, the yard waste is typically required to be stored in special waste collection bags for pickup. However, other municipalities only require the use of plastic bags for holding this yard waste. Hardware, grocery and convenience stores generally sell either paper or plastic yard waste collection bags that are compliant with the regulations governing such disposal and recycling of yard waste.

When using these yard waste collection bags, several problems and annoyances are obvious. The paper bags are difficult to initially open and to then hold open while filling, and plastic bags are difficult to hold open in a supported position so as to allow for easy insertion of the yard or garbage waste.

There are many existing apparatuses for aiding in the use of waste collection bags. The prior art devices generally fall into two categories; the first is a group of devices used to ease opening of either paper or plastic bags and consequently aid in holding them open. U.S. Pat. No. 6,155,522 discloses a yard debris collecting system utilizing a pivoted frame, a chute couplable to the frame and a collection bag couplable to the frame such the chute extends into and opens into the open bag. However, the frame of the '522 patent would prevent easy removal of the frame from the interior of the bag when the bag is full of trash or yard waste. In addition, pivoted frame does not hold the bag securely in place so that it does not slip down when being filled.

The frame is further provided with bent feet, which would also prevent the easy removal of the device from inside the bag. U.S. Pat. Nos. 5,292,093; 5,129,609; and 4,037,778, and Publication No. U.S. 2004/0026578 all show the use of accordion style cardboard or hard plastic inserts which can be placed into either paper or plastic waste collection bags and then be unfolded to assist in opening the bags. The inserts are sufficiently rigid to hold the waste collection bags upright for easy filling. For example, the bag insert of the King et al. Publication set forth above describes an accordion style insert that can be inserted into a paper yard waste bag to expand the bag and maintain it in an upright and open position. Once installed, the yard waste can now be inserted into the bag by dropping the waste through the open top of the bag insert.

After waste collection is complete, the bag insert is capable of being folded along several axes such that the size of the bag insert is reduced for storage. The other three issued patents listed above all show similar expandable inserts for use with plastic yard or garbage waste bags which can be unfolded to expand the plastic bag and hold the bag in the open position for filling with yard waste or garbage waste. However, each has to be removed from the interior of the bag it is inserted in after the bag is filled, a task that is messy and difficult to achieve, especially with plastic bags that tend to rip or tear during the task. When removed from the bag, the inserts can be folded up for storage. However, these inserts force the user to come in direct contact with the waste when trying to recover the inserts when the bag is filled. Even if the inserts were made to be disposable, this would add to landfill waste and would need to be very inexpensive since they are being disposed of when used.

The second group of patents relate to devices that hold one end of a plastic yard waste bag open such that the bag can be placed on its side in an open position to allow for filling with yard waste. U.S. Pat. Nos. 5,107,666; 5,106,041; 4,832,292; and 3,934,803 all show devices, which can be used in this fashion. For example, the Paulus, Jr. reference (U.S. Pat. No. 3,934,803) shows a bag supporting device for holding a plastic yard waste bag with its receiving end in an open position essentially perpendicular to a horizontal surface to permit leaves and trash to be raked or swept into the interior of the bag. In some cases these devices are provided with integral scoops to allow for easy access to the bag. However, once the bag is filled the user is still left to struggle with the filled bag in order to get it to the sidewalk for disposal. In addition, many of these holders lack a securing system to hold the waste bag to the device and/or to hold the device from sliding when being filled with debris especially when tilted to receive waste in the horizontal position. In the patents that provide a securing device to prevent the device from moving while the bag is filled, these can only be used on soft surfaces such as a lawn since the spikes used to secure the device from moving would not penetrate a hard surface without damaging the surface.

While these devices may fulfill their respective, particular objectives and requirements, the above-mentioned patents have many shortcomings and are limited in their use. In particular, the above discussed patents do not disclose a new yard waste collection system that can be used with both paper and plastic yard waste bags that is designed to hold open such bags, secures the bags in place when laid in the vertical and or horizontal position and can be wheeled away once manipulated to the upright position. Additionally, these features are not taught together with a novel double-rimmed bag securing mechanism that effectively secures the plastic bag in place when the first and second rims are set in place and allows for easy removal of the bag when the first rim is separated from the second rim. This system assures that the bag stays in place and does not lead to problems such as spillage of the contents of the bag either as the bag is being filled or when the bag is being removed out of the device.

The present invention as described below teaches such a device and overcomes the shortcomings of the prior art references discussed above.

### SUMMARY OF THE INVENTION

The present invention is directed to a trash bag holding and transportation device comprising a rim and a frame. The frame has an upper portion and a lower portion connected together to form a frame support having a greater length than width. The upper portion of the frame is configured to attach the rim and supports the rim off the ground when the trash bag holding device is in the upright position. The trash bag holding and transportation device further comprises a wheelbase attached that is attached to the lower portion of the frame. The wheelbase has at least one wheel and a support for supporting items placed thereon. In the alternative, the wheelbase can have two wheels and each of the wheels can be attached to each other by an axle, which attaches to the frame. Alternatively, the wheels can be independently attached to the wheelbase portion of the frame. The wheelbase is also fitted with a support or platform that is designed to support a filled trash bag or similarly sized items. One design o for the support is a flat design that extends forwardly much like the platform in a hand truck.

The rim of the trash bag holding device of the present invention may have a double rim system having an outer rim that is slightly larger than an inner rim. The inner rim is configured to fit tightly within the outer rim so as to sandwich a plastic bag placed in between in place. That is, the outer and inner rims are configured so that the clearance between the rims is large enough to fit a plastic bag but not oversized so as to allow the plastic bag to slip from the double-rimmed system. The double-rimmed system can be made from a semi-rigid or rigid material in a substantially circular form. In alternative embodiments, the double-rimmed system can be in the form of a half circle, oblong with one flat side, triangle, or a rectangle.

The trash bag holder of the present invention may comprises a clamp that can be either permanently or removably attached to at least one of the rims of the double rimmed system and is configured for securely holding a trash bag to at least one rim of the device. In the alternative, a clamp can be used instead of the double-rimmed system but the double-rimmed system is preferred.

The trash bag holding device of the present invention may further comprise an anti-slip system that is attached to the rim system or frame and prevents the trash bag holding device of the present invention from sliding and/or “walking” on the ground when the device is used in the horizontal position. In one embodiment of the present invention the device is equipped with retractable spikes/posts that insert into the lawn when in the extended position and retracted back into the device when in the transportation mold so as to prevent injury. In addition, the trash bag holding device of the present invention may further comprise an anti-slip gripping system that can be used on a hard surface like a driveway where the spikes/posts would not be used in order to prevent the device from slipping.

The present invention and its features are discussed in more details using the figures provided in the detailed description section of this document.

### BRIEF DESCRIPTION OF THE DRAWINGS

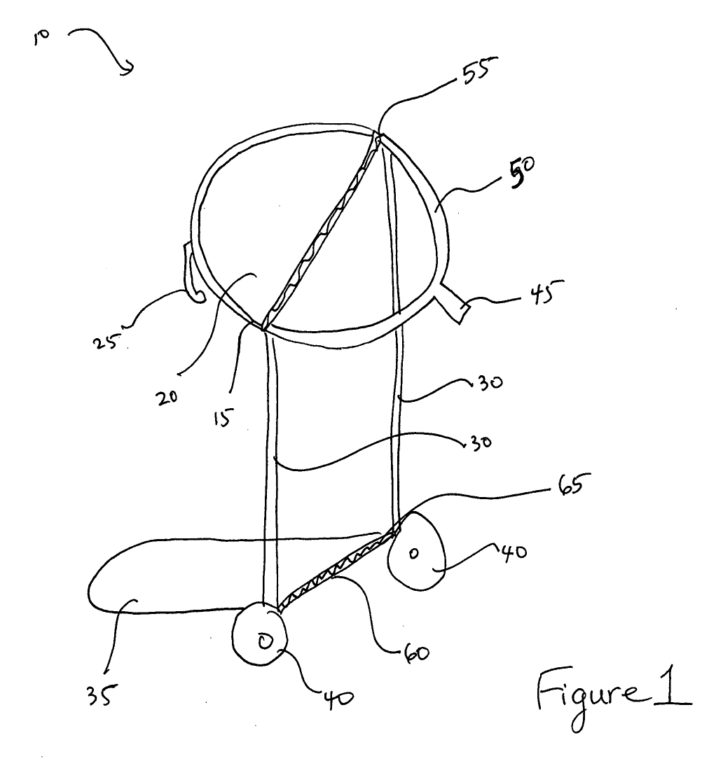

FIG. 1 is a side view of the trash bag holder and transporter of the present invention with the handle positioned to push the cart and the griping extensions in the retracted position.
10) Trash Bag Holder
15) Rim
20) Void
25) Trash Bag Locking Means
30) Supports
35) Trash Bag Support
40) Wheels
45) Handle
50) Push Bar
55) Hinge Means
60) Wheel base

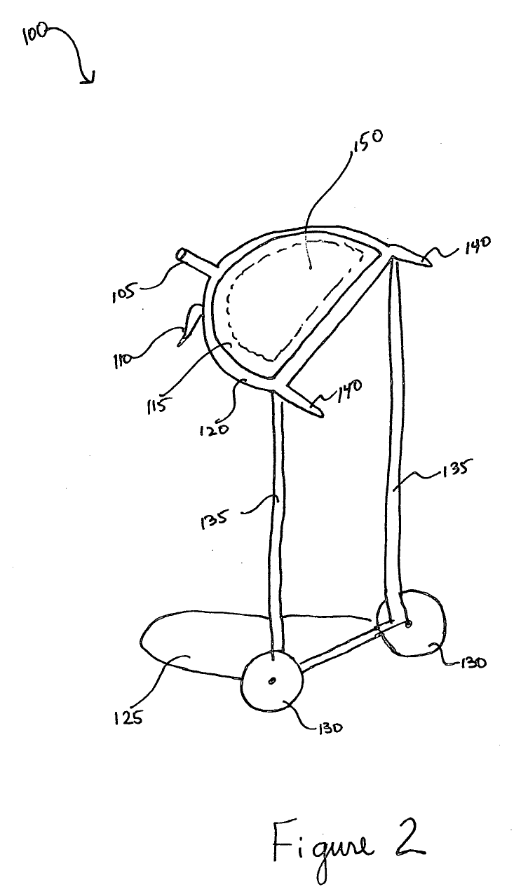

FIG. 2 is a side view of the trash bag holder and transporter of the present invention with the handle positioned to push the extended griping extensions into the lawn.
100) Trash Bag Holder with Extensions Tabs
105) Handle
110) Trash Bag Latching Means
115) Rim
120) Pushbar
125) Trash Bag Support
130) Wheels
135) Support
140) Griping Means
145) Hinge Means
150) Void

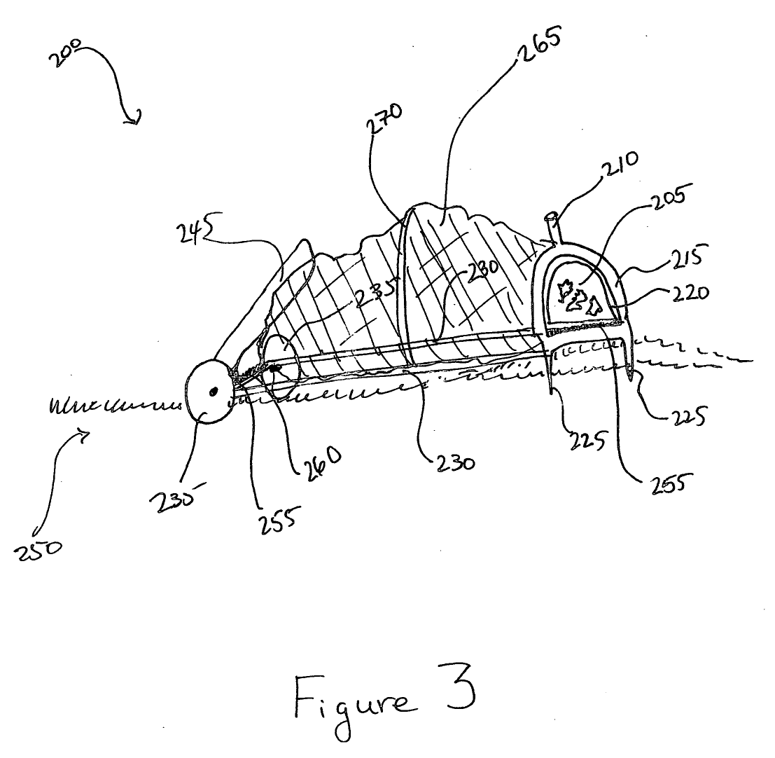

FIG. 3 is a side view of the trash bag holder and transporter of the present invention with the extended griping extensions embedded into the lawn.
(200) Trash Bag Holder with Extensions Tabs
(205) Void
(210) Handle
(215) Push bar
(220) Rim system
(225) Extension tabs
(230) Support means
(235) Wheels
(240) Wheelbase
(245) Trash bag support means
(250) Lawn
(255) Hinge means

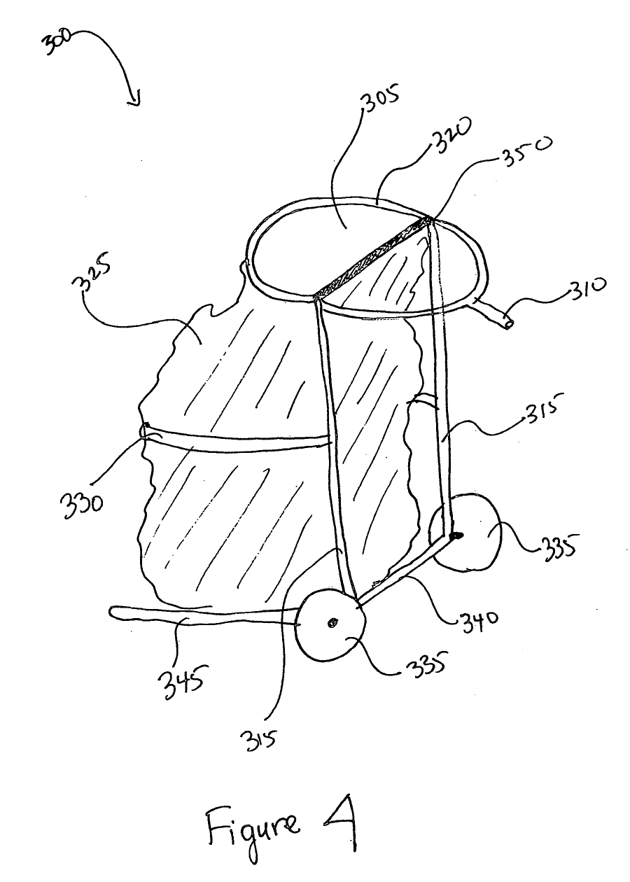

FIG. 4 is a side view of the trash bag holder and transporter of the present invention with a filled trash bag attached in the up righted position.
(300) Trash Bag Holder with Extensions Tabs retracted
(305) Void
(310) Handle
(315) Support Means
(320) Rim system
(325) Filled Trash Bag
(330) Tethering device
(335) Wheels
(340) Wheel base
(345) Trash bag support means
(350) Hinge means

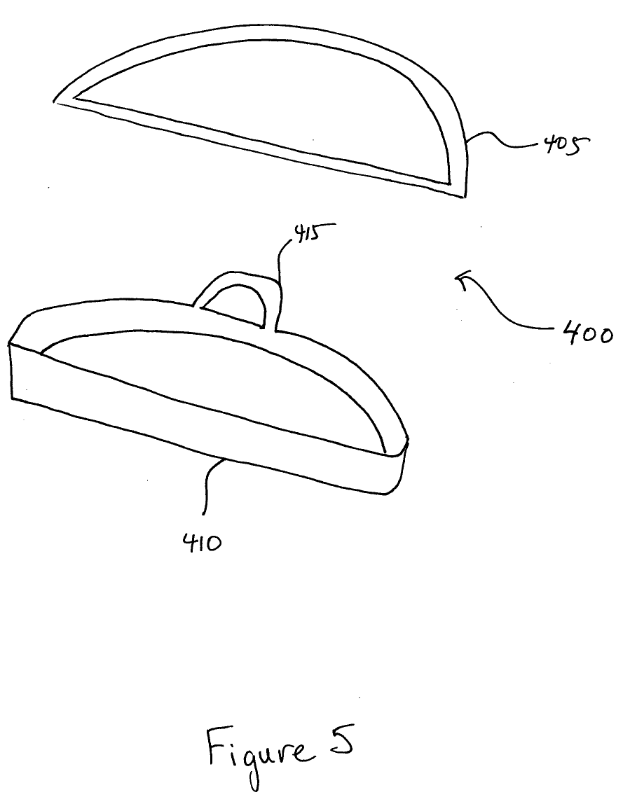

FIG. 5 shows a side view of one embodiment of the rim system assembly of the present invention.
(400) rim system assembly
(405) first section of rim system assembly
(410) second section of rim system assembly
(415) handle

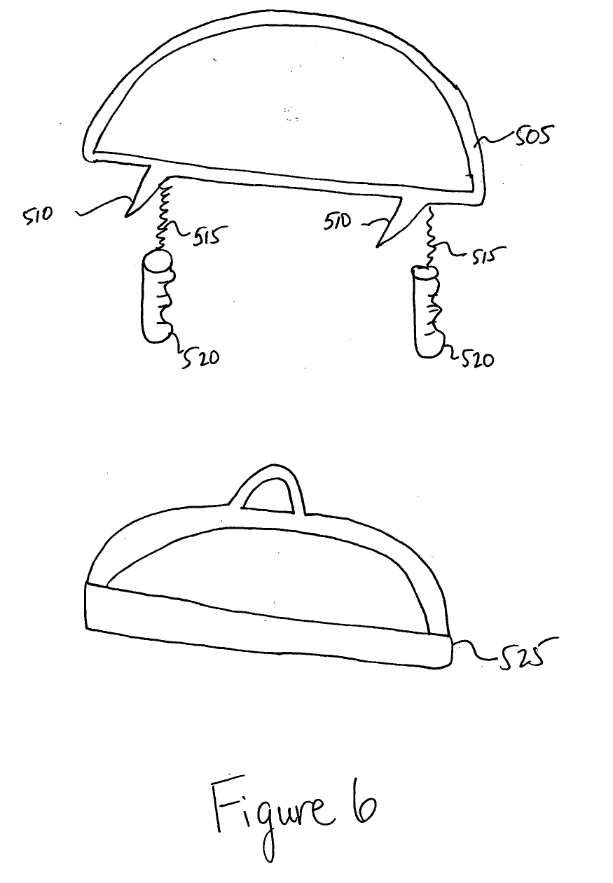

FIG. 6 shows a side view of one embodiment of the rim system assembly comprising spikes and grips of the present invention.
(500) rim system assembly
(505) first section of rim system assembly
(510) spike
(515) elastic attachment means
(520) grip
(525) second section of rim system assembly

### DETAILED DESCRIPTIONS OF THE INVENTION

The present invention is directed to a trash bag holder and transporter. In particular, the present invention is directed to a device that can be used to secure a plastic or paper trash bag in an open position so that debris i.e. leaves, can be raked into the open bag. One object of the present invention is that the trash bag holder is constructed so that it can be manipulated from a horizontal position in which the opening of the trash bag is adjacent to the lawn/floor to allow leaves or other debris to effortlessly be raked into the trash bag. When the trash bag is almost filled the device can be manipulated into the upright position. In the upright position with the filled trash bag still secured to the rim of the device, the bag remains in the open position so that the remainder of the trash bag can be filled. When the trash bag is completely filled, the trash bag can be released from the rim of the device (as further described below and tied shut.)

Another object of the present invention is that the device is configured in such a way so that when the trash bag is released from the rim of the device, it can be tied and remain associated with the device. The device of the present invention can be equipped with wheels which would make transporting the filled, tied trash bag ready for disposal to the curb for garbage pick-up.

Still another object of the trash bag holding/transporting device of the presented invention is to provide a gripping system that is designed to prevent the device from creeping away from a user as leaves are raked into the open trash bag when in the horizontal position. The device may also be equipped with a locking system in communication with the wheels so that the wheels can be locked to further prevent the creeping away of the device when used in both the horizontal and vertical positions. This prevents the possibility of the device from creeping away from the user as leaves are pushed into the open mouth of the trash bag. Similarly, the braking system also prevents the device from sliding away from the user when the device is perched on an incline while being used. Another object of the present invention is to be equipped with a griping system that can be used on both hard and soft surfaces. For example, the griping system should be able to be used to prevent creeping away from the user when the device is used on the black top of a driveway as well as when the device is used on the lawn.

Still yet another object of the device is to contain a trash bag securing means that is able to secure the trash bag to the rim of the device firmly enough so as not to be released when locked down, but not so firmly held that the trash bag tears as it is filled. The rim system can also be separated from the trash bag holding device so as to be used as a standalone device. The rim system of the present invention has an outer and inner rim. The outer rim is slightly larger than the inner rim so that the inner rim fits with the outer rim. To use the rim system a plastic (or paper) bag is positioned over the outer rim of the device. When the inner rim is closed it sandwiches the bag against the inside surface of the outer rim and secures it in place. When the inner rim is locked within the outer rim, it is almost impossible for the bag to slip out of the grip of the sandwiched rims. The rims can either be attached to one another by a hinge or be two separate parts. It is a preferred embodiment of the present invention for the inner and outer rim to attach to each other by a centrally located hinge. The rim system of the present invention virtually eliminates the mess that can results when a bag either slips into a garbage can and the garbage placed in the can falls outside of the bag messing up the garbage can. That is, the rim system of the present invention provides a superior bag holding system than eliminates the problems associated with the conventional draping of the bag over the outside rim of a trash can and hoping that it does not fall off of the rim.

Another object of the present invention is to provide a detachable rim system that can be used with other trash cans/refuge storage devices in both a private and public settings. The outer rim of the detachable rim system can be configured so as to have an additional channel on its outside portion so it can be slipped onto the rim of a trash can and position the rim system so it can be used to hold the trash bag therein. Once in place, the inner rim can be lifted from the outer rim, a bag placed therein, and the inner rim closed so as to hold the trash bag in place as it does when associated with the present device.

Another object of the present invention is to provide a rim system that is made from a material that is sturdy enough to withstand the wear and tare associated with repeatedly being taken off and on of a trash can but, is capable of changing shape. The rim system can be formed with a memory of a particular shape, i.e. circle, but can easily be transformed into a different shape by placing the rim system around the rim of a trash can/trash pail, i.e. a rectangular shaped can. A circular device is preferred since there will be no corners and when the device is re-formed onto a non-circular trash can rim it fits without having any protrusions caused by corners. For example, the rim systems can be used at festivals/parties when many trashcans are provided throughout the festival/party grounds for garbage disposal and/or recyclable collections. The double-rimmed system assures the cleaning/collecting crews that the plastic bags will not slip out of place and create a mess/spill. The device can also be used in a normal kitchen garbage compartment to prevent the bag from slipping into the can and the kids piling on the garbage even though the bag is clearly off of the rim.

The trash holding/transporting device of the present invention realizes these and other objectives. In addition the device of the present invention is easy to use, easy to store, and versatile enough to be used for any project that requires disposal of debris into a trash bag. The present invention is further described below and in the figures of the present invention.

In one embodiment of the present invention the trash bag holding and transportation device comprises a rim specifically designed to tightly hold the plastic garbage bag an open position. The rim system can be as simple as a series of clips cushioned so as to allow them to firmly press the trash bag against the rim of the device without tearing the bag or the combination of an inner and outer rim that fits within one another to sandwich the plastic bag in place. In one embodiment of the present invention the rim system is in the shape of a halve circle with the flat portion configured to contour a flat surface in which it can be used. In the alternative, the rim system can be made of a moldable, durable material that is firm enough to secure the trash bag in the open position, but moldable enough that it can conform to an uneven surface.

In yet another embodiment the double-rimmed system can be adjustable to accommodate different size trash bags/trashcans. For example, if the device is being used to hold open a construction trash bag that is usually smaller in diameter than a leaf bag, the rim can be adjusted so as to fit the construction trash bag and then readjusted to fit a leaf bag when the device is used to pickup leaves. A preferred embodiment of the rim system of the present invention has an outer and inner rim that can either be connected to each other by a hinge that permits the inner rim to removably fit within the outer rim about the hinge. The hinge should be large enough o keep the two rims in place but not so large as to reduce holding power of the bag when sandwiched between the two rims. The rimmed system can also have a lid attached to the same or different rimmed system so that the lid could be used to cover the trash can when not in use. If outside, this could reduce the number of flies/bees that gather about the garbage and/or reduce the odor from trash placed in therein. The lid is especially useful in kitchens where food waste and other odorous garbage are thrown away.

The device may also be equipped with a single rim and a clamping system that is movably attached to the rim so as to secure the plastic bag to the rim. The clamping system can be configured so that a trash bag positioned with the rim system is uniformly clamped to the rim and trash bag is uniformly held about the entire circumference of the bag. Uniformly clamping the trash bag to the rim makes it less likely that the trash bag will tear in any one given point. In one embodiment of the present invention, the clamping means further comprises a spring strip having a central portion configured in a substantially circular shape wherein the spring strip is compressed to permit an open end of a trash bag to be placed there over. Once the trash bag clamping system is in position, the spring strip can be released so as to clamp the bag securely to the rim of the device. The clamping system can be adjusted to a second position, which releases the trash bag from said clamping system so that it can be disposed and allows for empty trash bag to be reloaded onto the rim. In the alternative the rim can be both double-rimmed and have clips.

The device of the present invention is also equipped with a frame that is either releaseably or permanently connected to the rim system at the upper end of the frame and is attached to a wheel base at the opposite, lower end of the frame. The frame can be as simple as a single support bar attached/attachable to the rim system at one end and a wheelbase at the other end of the frame. The frame is designed to support the weight of full bag of debris, but is not so bulky as to add unnecessary weight to the device. The frame can be made of stainless steel, aluminum, alloy, plastic, polyvinylchloride (PVC), polyurethane resins, nylon spun resin material, such as, fiberglass, man-made materials, powder coated steel, am made materials or any other material that is economical, durable, and has a high strength to weight ratio.

The frame can be equipped with a wheelbase that comprises at least one wheel and is used for transporting the trash bag holding device from one place to another. The wheelbase can be constructed to have two wheels connected by an axle and the axle can be connected to the frame. The wheels can be fixed to the axle in one orientation so that the device can be used in the same manner as a wheel truck or can swivel to give maximum movability.

The device may be further equipped with an anti-slip means for preventing the device from moving while it is being used can be attached to the device. In one embodiment the anti-slip means is attached to the rim system and can be as simple as a rough surface designed to increase friction on a surface so as to prevent sliding. In the alternative, the anti-slip means can be small spikes that can be pushed into the ground to prevent the device from moving. The spikes can be attached to the rim by a rim and in the retracted position have anti-slip material, such as rubber or particulate paint the side of the spikes that will impact the ground when in the folded position. This allows the folded spikes to act as a griping mechanism to prevent the device from creeping when used on a hard surface like a driveway.

In one embodiment of the present invention, the spikes retract into a portion of the rim system so as to prevent the spikes form injuring the user when not in use. Once retracted, at least a portion of the rim system can be coated or covered with an anti-grip material that prevents the device from slipping on a hard surface. Alternate embodiments of the grip means of the present invention envisioned by one skilled in the art are also part of the invention.

The present invention is now described in connection with FIG. 1. FIG. 1 shows a schematic profile view of the trash bag holder of the present invention (10) in the upright position. This embodiment is shown with a wheelbase (60) having two wheels (40) but the trash bag holder of the present invention can be envisioned with one wheel or multiple wheels and even without a wheelbase at all. In the event that the embodiment is configured without a wheelbase at all, the device will have a blunt end (not shown) in which the device rests on when in the upright position.

At the other side of the trash bag holder (1) is a rim system (15) that can have any shape. In a preferred embodiment of the present invention, the trash bag holder (10) has a semi-circular shape so that when placed on the ground the substantially flat portion of the semi-circular shape is substantially flushed with the ground. In one preferred embodiment of the present invention, the substantially flat side of the rim system (15) is one the same side of the invention as the wheelbase (60). The rim system (15) produces a void (20) that is large enough for a trash bag positioned around the rime system (15) to be held open so that debris can be either raked or deposited into the open trash bag.

The rim system (15) is attached to the wheelbase (60) by a frame support system (30). The frame support system (30) can consist of one, two or more substantially straight support polls or a solid frame. The frame support means can either be fixed in length or adjustable in length. One embodiment of the invention can have adjustable frame support means that are designed to telescope in and out from each other so as to provide varying heights of the device but also to provide a convenient way of storing the device. Once a desired height or storage position is achieved, the telescoping poles can be locked into place using either a hole and pin or tension locking system that is well known in the art. Alternative locking means can be used and will not take away the inventive concept of the present invention.

One benefit that can be realized by having a telescoping frame is that the telescoping poles can be telescoped to be less than the full size wherein the rim system (15) is brought closer to the wheelbase (60) drastically reducing the overall storage height. This allows the device to be stored easily in the garage or shed when not in use.

Attached to the wheelbase (60) and projection outwardly is a trash bag support means (35) designed to support a filled or partially filled trash bag when the device (10) is in the upright position as shown in FIG. 1. The trash bag support means (35) can be attached to the frame support means (30) or the wheelbase (60) and can be designed so as to fold up when not in use for easy storage.

In one embodiment of the present invention, the rim system (15) is equipped with a trash bag locking means (25) that is designed to gently but firmly press the trash bag to the rim system (15) in the open position securely but without tarring the plastic bag. In other words, the locking means (250 is designed without sharp or piercing edges so as to secure the bag to the rim without compromising the integrity of the plastic bag. Doing so would cause the plastic bag to continue to tear and result in the contents of the bag either falling out placing the user back to where he or she started. Therefore, cushioned bushings, such as felt pads, must be used in order to avoid such problems. A spring loaded locking means can be used in order to secure the trash bag to the rim system and once the trash bag is filled, the trash bag locking means (250 can be released so as to allow the trash bag to be tied and wheeled to the curb for trash disposal.

The rim system (15) may also be equipped with a hinge means (55) positioned at the substantially flat portion of the device that attaches a push bar (50) to the device. The push bar (50) attached to the rim system (15) by hinge means (55) can be positioned in at least two positions. In the first position the push bar (5) is extended furthest away from the rim system and locks into place. Once locked into place, the push bar can be used by the user to push the device, either with a filled trash bag or not, on the wheels (40). The push bar can be further equipped with a handle (45) that allows the user to hold the push bar with one hand to maneuver the device to the desired location. Once in the desired location the push bar (50) can be unlocked and turned on the hinge means (55) to lay flush with the rim system (150) and be out of the way. In one embodiment, the push bar (50) is used as part of the trash bag locking means (25).

The trash bag holder (10) shown in FIG. 1 can be used in both the horizontal and upright position. In the horizontal position, the device (10) having a trash bag secured by the trash bag locking means (25) to the rim system (15) in the open position can be laid down on a lawn so that leaves can be raked into the void (20) of the trash bag opening. The device can be laid down on the substantially flat portion of the rim system so as to lie close to the lawn making raking the leaves into the bag easy. Once the bag is at least half filled the device can be up righted so that the filled bag rest on the trash bag support (35). The trash bag can be released from the trash bag locking means (25) and tied. The push bar (50) can be moved about the hinge means (55) so that the device (10) can be pushed about on the wheels (40) of wheelbase (60).

In the alternative the trash bag can remain attached to the rim system (15) until the bag is filled and then removed from the rim by releasing the locking means (25). Once positioned on the trash bag support, the trash bag can be wheeled to either a storage place or to the curb for disposal.

FIG. 2 shows a schematic profile of the trash bag holder (100) of the present invention in an up righted position with the push bar (120) in the inoperative position and the grasping extensions (14o) extended out from the substantially flat portion of the rim system (115). The griping extensions shown in FIG. 2 are in the shape of small spikes designed to embed into a soft surface such as a lawn when the trash bag holding device (115) is laid flat on a lawn. Although the spikes will penetrate into the lawn because of the weight of the device (115), to assure a proper grip the device may be shoved into the lawn.

With a trash bag secured to the rim system (115) and the push bar (120) in the closed position with the spikes extended, the device (100) of the present invention is ready to be positioned on a lawn. If the user desires to fill the trash bag while it remains in the up righted position, the push bar (120) should remain extended in the locked position so as retract the spikes and protect the user from harm. When the push bar (115) is rotated about the hinge means (145) into the extended the position, the spikes are retracted, the handle (105) is positioned on the same side of the wheels (130) and the device can be pushed using the push bar (115).

As the trash bag remains attached to the rim system (115), the weight of which is supported by the support means (135), it can be moved to the next position and either used in the up righted position or laid down on the lawn so that leaves can be raked into void (150) into the trash bag.

FIG. 3 shows a schematic profile view of the trash bag holder with a trash bag attached, the push bar (215) closed against the rim system (220) and the extensions tabs (225) extended into the lawn (250). The rim system (220) can be stepped on or otherwise shoved towards the lawn (250) so as to further embed the extension tabs (225) into the lawn (250) to prevent the trash bag holder (200) from creeping as leaves are raked into the trash bag. Once the device is in position on the lawn, debris can be raked and/or swept into the trash bag until it is filled. Once it is filled the handle (210) on the push bar (215) can be used to pull the extension tabs (225) out of the lawn (250) so that the trash bag holder (200) can be up righted. The support means (230) pivots about the wheels (235) until it up righted.

Once up righted the push bar (215) is pivoted about the hinge means (255) and the extension tabs (225) are retracted. In the alternative, the push bar (215) can be moved so while being up righted so that when the trash bag holder (200) reaches the up righted position the extension tabs (225) are already in the retracted position.

FIG. 4 shows the trash bag holder of the present invention (300) in the up righted position with a filled trash bag positioned on the trash bag support (345) and optionally held in place by a tethering means (330) which is attached to the support means (315) and can be stretched around the trash bag (325). The tethering means (330) can be faceted prior to lifting the trash bag (325) and the trash bag holding means (300) to the upright position.

In another embodiment of the present invention, the rim system (400) is designed in two interlocking pieces. As shown in FIG. 5, the first section (405) is part of the trash bag holding device and has a solid rim void of sharp edges. The second section (410) is removable and fits within the first section (405). Both the first and second sections of the rim system has a relatively flat smooth inner surface so that when a plastic bag is placed over the rim of the first section (405) of the rim assembly (400) it will not tear and/or rip the plastic bag. The second section (410) of the two-part rim system (400) of the device is not attached to the device but is designed so that it can be fit snuggly within the inside portion of the first section (405). As with the first section (405) of the rim system (400), the surfaces should be flat and relatively smooth so as not to tear or rip the plastic bag when it comes in contact with the bag. The second section (410) of the rim system (400) can be flared inwards or crafted to be straight down, but regardless of the shape this piece of the rim system must be designed to mate with the first section (405) of the system so as to temporarily interlock and hold the plastic bag in place.

The rim system (400) is designed to compress the trash bag against each of the two mating surfaces of the rim system (400) so as to hold the bag in the open position and prevent the bag from slipping out of the device once debris is placed into the bag. That is, the double-rimmed two-section rim system (400) is designed to “sandwich” the plastic trash bag within the two locking pieces so as to hold the bag in place. Once the bag is filled and the device is wheeled to the curb to allow for proper disposal of the attached filled plastic garbage bag, the second piece (405) e.g., the inner portion of the rim system system, can be removed and the plastic bag allowed to fall out of the rim system (400) so that the plastic bag can be tied. The second section (405) of the interlocking rim system of the device can be configured to have a handle (415) opposite the flat portion of the rim system that can be used to steer the device and aid in removing the second section (410) the rim system (400) when the bag is to be released. It is important that the handle (415) located on the second section of the rim system (400) be designed so as to not interfere with the temporary interlocking of the first and the second sections (405) and (410) of the rim system (400) of the device.

This alternative embodiment, requires no moving parts, such as springs and levers as described in other embodiments of the present invention, and therefore is more economical to produce and possibly easier to use. The two section rim system (400) can be made from the same material as the rest of the device, including but not limited to resin, Poly Vinyl Chloride (PVC), manmade materials, plastics, rubber composites and the like. Regardless of what material is used to make the rim system (400), the rim system (400), as well as the rest of the device, should be constructed out of a material that is sturdy and can be easily washed with a garden hose should it be necessary to clean.

In an alternative embodiment of the double-rimmed system, the double-rimmed system has an outer rim and an inner rim and is designed to be removed and/or stand-alone from the trash bag holding device of the present invention. The outer rim is designed to be slightly larger than the inner rim whereby the inner rim fits tightly within the outer rim to sandwich a trash bag in place. The double rimmed-means can be configured with a hinge that connects the outer rim to the inner rim in a moveable configuration. The outer rim can be equipped with a latching system that is configured to attach the double-rimmed system to the frame in a manner so as to allow it to be operably attached to the frame of the device. The outer rim may also be equipped with a handle that makes the separation of the rims easy. The removable double-rimmed system may also be equipped with all or some of the additional attributes of the rim system shown in FIG. 1.

The double-rimmed structure shown in FIG. 5A can be made from a material that is sturdy enough to withstand the wear and tare associated with repeatedly being taken off and on of a trashcan but is capable of changing shape. The double-rimmed system can be formed with a memory of a particular shape, i.e. circle, but can easily be transformed into a different shape by placing the rim system around the rim of a trash can/trash pail, i.e. a rectangular shaped can. A circular device is preferred since there will be no corners and when the device is re-formed onto a non-circular trash can rim it fits without having any protrusions caused by corners. For example, the double-rimmed systems can be used at festivals/parties when many trashcans are provided throughout the festival/party grounds for garbage disposal and/or recyclable collections. The double-rimmed system assures the cleaning/collecting crews that the plastic bags will not slip out of place and create a mess/spill. The device can also be used in a normal kitchen garbage compartment to prevent the bag from slipping into the can and the kids piling on the garbage even though the bag is clearly off of the rim. The double-rimmed system is so effective that it can be referred as an “a-sure-a-grip” rim.

With the “a-sure-a-grip” rim, any trash bag properly placed between the two closely interlocking rims will not become dislodged from the rim even if the trash bag is filled with plastic/glass containers. This is a key feature in making the device of the present invention useful and user friendly since a dislodged trash bag will be messy and probably discourage the individual from recycling, at least during the party in fear of a repeat performance. In addition, multiple devices can be used as a permanent recycling system since the can be set up in the garage or outside bin to separate glass from plastic from aluminum.

The present invention is better than using either a traditional trash container alone or with a trash bag inserted therein to prevent soiling of the container for at least the following reasons. Since the “a-sure-a-grip” locking rim system of the present invention prevents the trash bag from ever slipping out of place, the present invention avoids the messy scene that results when a trash bag dislodges from the rim of the trash container and either slides down the pail and/or spills on to the ground. In addition, since the present invention is wheels, the device can be wheeled to the curb on pickup day, the rim lifted and the plastic bag tied and placed the curb without ever lifting the trash bag and risking tarring and/or straining the user's back. This make the device of the present invention ideal for elderly, people with back conditions and/or anyone that wants to spare themselves from the clean-up associated with using the traditional containers. This easy to use device is most certainly reduces the extra effort associated with consumer recycling and therefore will lead to increased consumer recycling.

In still yet another embodiment of the present invention, the trash bag holder and transporter can be equipped with at least one lawn spike as shown in FIG. 6 which can be covered by grips (520) that also function as handles for transporting the device around. These grips (520) would serve to protect the user from injury when the spikes (510) are removed from the ground by fitting the grips (520) over the spikes (510) and covering the spikes so as to avoid injury. The grips (520) can be designed to automatically cover the spikes (510) as the spikes (510) are removed from the lawn and the device moved to the upright position. These grips (520) can be attached to the device by an elastic material (515) that when pull straight out retracts back to cover the spikes (510). The force created by the tension in the stretched elastic material 515 assures that the grips (520) remain on the spikes (510) and do not fall off in transport. When the spikes (510) are to be removed so that they can be inserted into the ground, the user can simply pull against the resistance of the elastic (515) and stretch the elastic (515) until the grips (520) are clear of the spikes (510) so that the spikes (510) can be made available to be inserted into the ground and prevent the device from creeping when used in the horizontal position. This embodiment can also be used with a rim configuration described above or with the rim assembly described earlier in this Letters for Patent.

The various devices of the present invention can be used not only for yard and construction debris but also as a recyclable collection system for large event gatherings. In other words, the plastic bag holder can be used to collect recyclables at home or at business functions. This device allows for pre-sorting of plastics and glass and once the bag is filled the device can be wheeled to the curb to dispose of the recyclables on collection day. In the alternative, the filled bag can be wheeled to the car so that it can be placed into a car and taken to a bottle redemption site. All in all, the device can be used for this and many other functions all of which are anticipated by the present invention.

Recycling programs have become more commonplace in the United States and other developed countries through the end of the twentieth century and the beginning of the twenty-first century as consumers, businesses and governments realized the environmental and economic savings to be generated through recycling of goods. The most commonly known recyclable materials are paper, corrugated boards, aluminum, steel and other sheet metals, batteries and certain chemical compounds, plastics of varying types and glass. The implementation of higher technology automated equipment in material recovery facilities (MRFs) has further enabled a large volume of material to be collected, sorted and recovered with increasing speed and efficiency.

Although industry still is responsible for producing the lion's share of the recycled material today, the consumer market provides up to 30% of the recyclables produced in the United States today. Most of the consumer recyclable material results from plastic, glass, and aluminum beverage and food containers that used to end up in the landfills but now are recycled. Although more and more people are becoming educated about the benefits of recycling most people that do not recycle do not do so because of the effort and inconvenience they believe is associated with recycling. That is, the inconvenience of separating of glass, plastic and aluminum and storing them separately in different colored pails. Therefore one additional object of the present invention is to provide an easy, attractive bag holding system that can be placed in the corner during an outdoor or indoor party that will securely hold a trash bag and allow for party goers to deposit their recyclables into the trash bag and when filled can be wheeled to the storage place, detached and tied without ever getting dirty or lifting the bag. Once embodiment of the present invention provides such a device.

While the invention has been illustrated and described with respect to specific illustrative embodiments and modes of practice, it will be apparent to those skilled in the art that various modifications and improvements may be made without departing from the scope and spirit of the invention. Accordingly, the invention is not to be limited by the illustrative embodiments and modes of practice.

What is claimed is:

1. A trash bag holding and transportation device comprising:
a rim;
a frame having an upper portion and a lower portion connected together to form said frame having a greater length than width, said upper portion of said frame configured to attach said rim so as to support said rim off the ground when said trash bag holding device is in the upright position; and
a wheelbase attached to said lower portion of said frame comprising at least one wheel and a support for supporting items placed thereon, said wheelbase configured to support said trash bag and said trash bag holding device in the upright position.

2. The trash bag holding device of claim 1 further comprising an anti slip means attached to said trash bag holding device, said anti slip means positioned so as to prevent said trash bag holding device from sliding when positioned horizontally on a surface.

3. The trash bag holding device of claim 1 wherein said anti slip means comprises at least one extendable peg configured for easy entry into a soft surface so as to prevent said trash bag holding device from moving along a surface as debris is pushed into an open end of said trash bag.

4. The trash bag holding device of claim 3 wherein said peg is connected to said trash bag holding device by a hinge, said hinge configured to permit said peg to fold substantially flat to said device in one position and substantially perpendicular to said device in a second position.

5. The trash bag holding device of claim 4 wherein said peg is attached to the upper portion of said frame and is at least partially coated with an anti-slip coating selected from the group consisting of rubber, high friction material, anti-slip paint, anti-slip thermal sprayed powder coating, and mixtures thereof.

6. The trash bag holding device of claim 3 wherein said upper portion of said frame further comprising a handle attached to said upper portion of said frame.

7. The trash bag holding device of claim 1 wherein said wheelbase comprises two wheels connected to said frame on the same side of said frame as said anti-slip means.

10. The trash bag holding device of claim 1 further comprising a bag-securing means for releasably securing a trash bag to said frame during transport.

11. The trash bag holding device of claim 10 wherein said bag-securing means is selected from the group consisting of a flexible strap, a tether strap, a stretchable cord, a clip, an adjustable belt and a plastic strap.

12. The trash bag holding device of claim 10 wherein said bag-securing means comprises at least one substantially rigid arm configured so as to come in direct contact with at least a portion of said trash bag being transported.

13. The trash bag holding device of claim 12 wherein said at least one substantially rigid arm is attached to said frame of said trash bag holding device by a retractable hinge so that said substantially rigid arm can be extended and retracted.

14. A rim for holding a trash bag in an open position comprising an outer rim and an inner rim, said inner rim configured to fit in and out of said outer rim and to secure said trash bag between said outer and inner rim in an open position.

15. The rim for holding a trash bag in an open position of claim 14 wherein said outer rim further comprises a hinge, said hinge is attached to said outer rim and to said inner rim so as to allow said outer rim to be lifted away from said inner rim while still remaining attached.

16. The rim for holding a trash bag in an open position of claim 15 wherein said outer and inner rims are made of a moldable flexible material having a memory wherein said outer and inner rims can be molded to fit onto a rim of a garbage can or pail.

17. The rim for holding a trash bag in an open position of claim 16 wherein said moldable flexible material is selected from the group consisting of plastic, rubber, synthetic materials, silicone-based material and mixtures thereof.

18. The trash bag holding device of claim 1 further comprising a lid configured to fit over said rim and cover a trash bag attached to said rim, said lid is attached to said upper portion of said frame, optionally by a hinge.

19. The rim for holding a trash bag in an open position of claim 14 further comprising a lid configured to fit over said outer rim and cover a trash bag attached to said outer and inner rim, said lid optionally attached to said outer rim, optionally by a hinge.
